(19) United States
(12) Patent Application Publication
(10) Pub. No.: US 2016/0063979 A1
(43) Pub. Date: Mar. 3, 2016

(54) MANUFACTURING METHOD AND STRUCTURE OF ELECTRIC GUITAR

(71) Applicant: Jeff Jerfu Liao, Wheaton, IL (US)

(72) Inventor: Jeff Jerfu Liao, Wheaton, IL (US)

(21) Appl. No.: 14/731,429

(22) Filed: Jun. 5, 2015

(30) Foreign Application Priority Data
Aug. 29, 2014 (TW) 103129840

(51) Int. Cl. G10H 1/34; B32B 38/18

(52) U.S. Cl. CPC G10H 1/342; B32B 38/1808; B32B 2307/10

(57) ABSTRACT

Provided are a manufacturing method and a structure of an electric guitar, which help simplify the difficult of manufacturing an electric guitar by using a hollow box, at least one fibrous board, and at least one metal board to replace the conventional way of manufacturing an electric guitar with solid wood. Further, through the inherent difference between the fibrous board and the metal board, electrical currents generated by a pickup may induce an effect of tone holding due to difference of conductivity. Further, the alternate arrangement of the fibrous board and the metal board varies the tone quality of the electric guitar. Advantages of easy manufacturing and better tone quality can be achieved.

### TECHNICAL FIELD OF THE INVENTION

The present invention relates generally to a manufacturing method and a structure of an electric guitar, which have a reduced manufacturing cost and provides a better effect of holding and a better tone quality.

### DESCRIPTION OF THE PRIOR ART

An electric guitar often has a body made of solid wood to reduce noise induced by feedback. Openings or troughs are made in the solid wood to receive and hold pickups, a bridge, and other control switches. For tone qualities of electric guitars, the kinds and quality of wood used are also subjected to severe limitations. Examples include poplar, alder, basswood, and maple. Thus, operations adopted, such as cutting, grinding, painting, and polishing, in a manufacturing process must be conducted with care and environmental protection issues may incur. Consequently, the manufacturing cost is generally very high. In addition, timbre and style of electric guitar make users very concerned about the shape of the instrument body, such as curvature and lines. This increases the difficult of manufacturing of a solid body of the stringed instrument.

Thus, there are certain issues of electric guitars that must be further improved and overcome:

(1) The use of solid wood is necessary for the purpose of reducing or eliminating excessive noise and this results in high degree of difficult for manufacturing, which has long troubled the manufacturers.

(2) The complication of the manufacturing process directly affects the market sale price and makes it hard for general consumers to purchase.

(3) Tone quality solely relies the quality of wood used and can only be adjusted through an effector.

### SUMMARY OF THE INVENTION

The primary object of the preset invention is to provide a body formed of a hollow box that is easy to manufacture and may be shaped in various and diversified forms and to provide fibrous board(s) and metal board(s) alternately stacked and positioned in the hollow box, and to have receiving spaced that receive and retain therein pickups and a bridge completely filled so as to achieve an arrangement equivalent to a solid wooden guitar body and also improve the tone quality of the electric guitar and achieve an effect of tone holding.

To achieve the above object, the present invention provides a structure, which generally comprises a hollow box, at least one fibrous board arranged inside the hollow box, and at least one metal board arranged inside the hollow box and alternately stacked with the fibrous board in such a way that a stacking thickness of the fibrous board and the metal board substantially corresponds to a thickness of an interior space of the hollow box, whereby tone holding may be produced and tone quality may be varied. As such, through the differences of hardness and density between the fibrous board and the metal board, the electrical currents produced in the pickups may induce an effect of tone holding due to the difference of conductivity. Further, the alternate arrangement of the fibrous board and the metal board may change the tone quality of the electric guitar. Further, the fibrous board and the metal board are securely and tightly held in the hollow box so that the three members collectively provide an arrangement resembling a solid wood guitar body, but preserving the tone quality and sound characteristics of an electric guitar, while lowering the difficult of manufacturing an outer casing shape.

The above-discussed technique helps overcome the deficiencies and drawbacks of the prior art and can surely achieve the above-discussed advantages.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded view of the present invention.

FIG. 3 is a flow chart of the present invention.

FIG. 4 is another exploded view of the present invention, taken from a different perspective.

FIG. 5 is a cross-sectional view taken along line A-A of FIG. 1

FIG. 6 is an exploded view of another embodiment of the present invention.

FIG. 7 is a schematic view illustrating the structure of said another embodiment of the present invention.

FIG. 8 is a flow chart of said another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

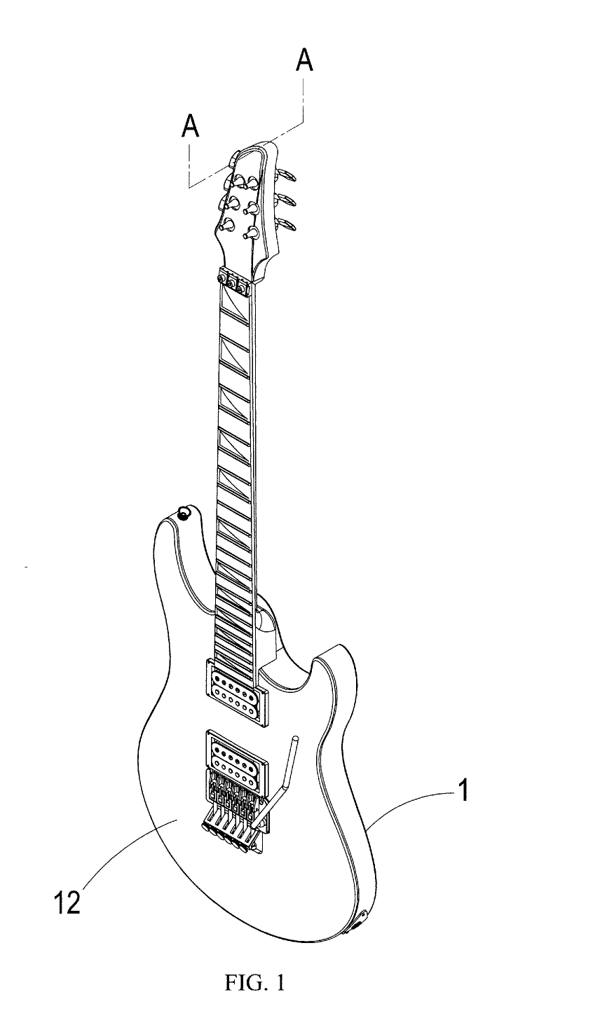

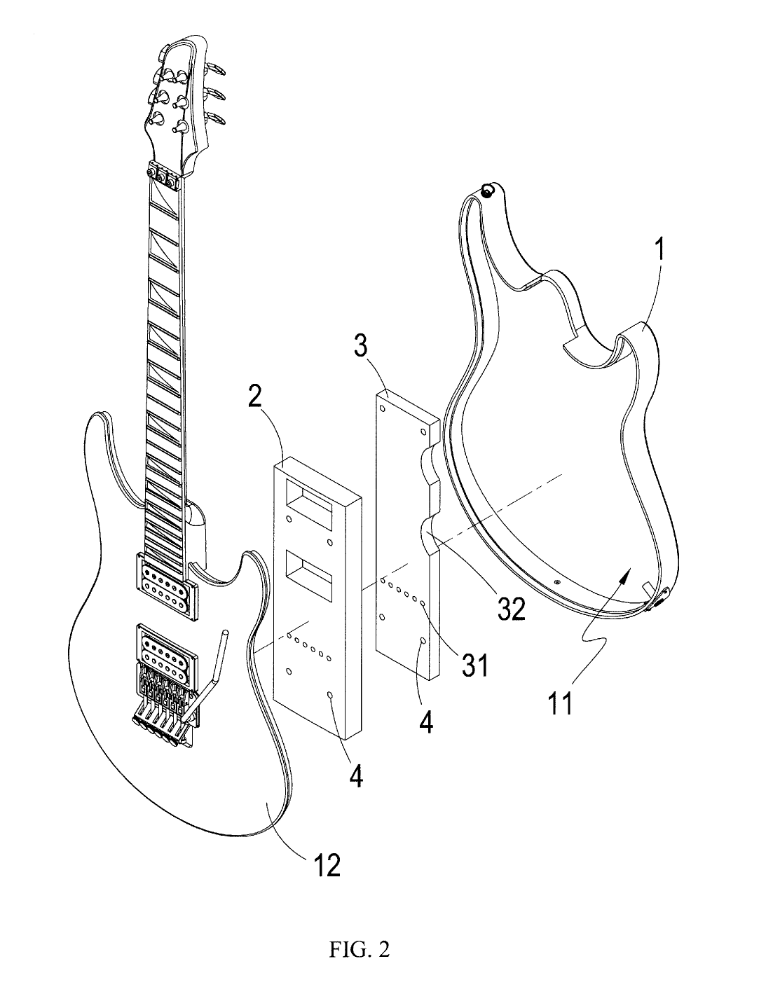

As shown in FIGS. 1 and 2, an electric guitar according to the present invention comprises:
a hollow box 1, which comprises a surface panel 12 to which a neck of the electric guitar is mounted;
at least one fibrous board 2, which is arranged in the hollow box 1, the fibrous board 2 comprises at least one receiving spaces 11 formed therein for receiving and retaining pickups or a bridge of the electric guitar;
at least one metal board 3, which is received in the hollow box 1 and stacked on the fibrous board 2, the thickness of the stack of the fibrous board 2 and the metal board 3 being corresponding to a thickness of an interior space of the hollow box 1, the metal board 3 comprising a plurality of openings 31 formed therein for receiving strings to extend therethrough, the metal board 3 further comprising at least one notch 32 formed therein; and
at least one mounting section 4 formed in each of the metal board 3 and the fibrous board 2 and in communication with each other.

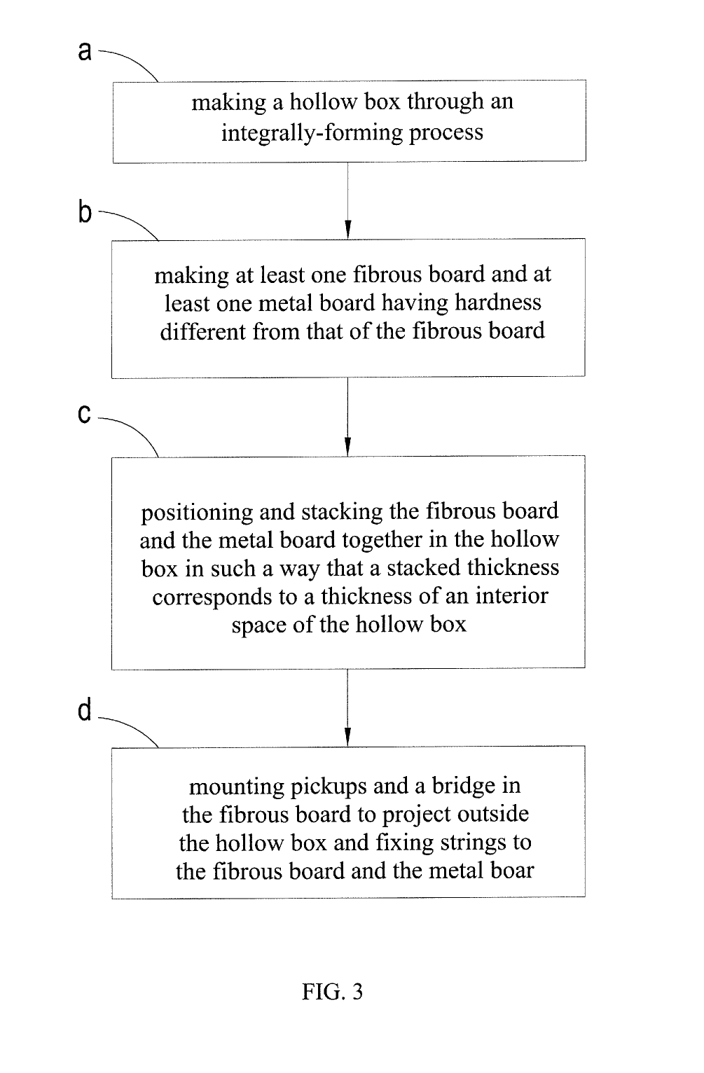

As shown in FIG. 3, the present invention provides a manufacturing method comprising the following steps:
(a) making a hollow box through an integrally-forming process;
(b) making at least one fibrous board and at least one metal board having hardness different from that of the fibrous board;
(c) positioning and stacking the fibrous board and the metal board together in the hollow box in such a way that a stacked thickness corresponds to a thickness of an interior space of the hollow box; and
(d) mounting pickups and a bridge in the fibrous board to project outside the hollow box and fixing strings to the fibrous board and the metal board.

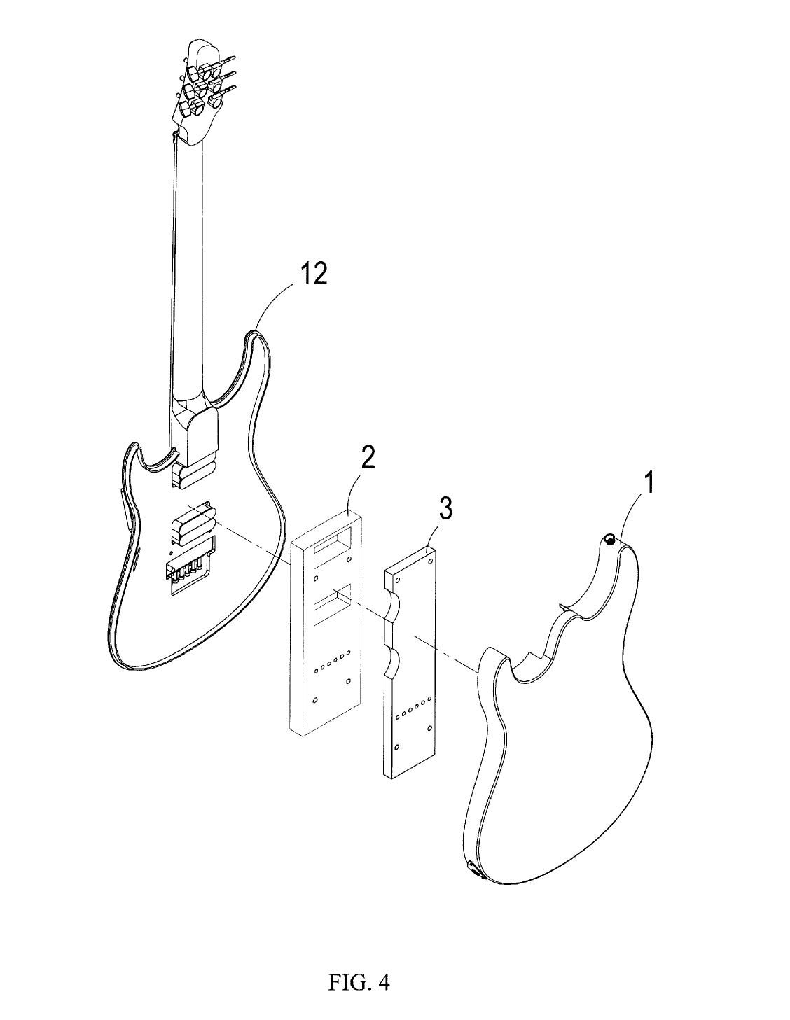

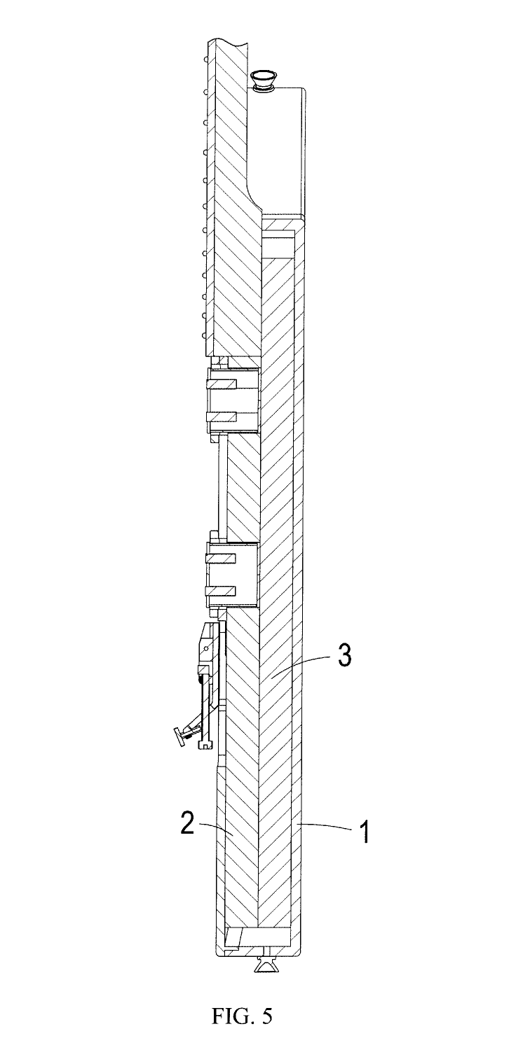

As shown in FIGS. 1-5, firstly, the electric guitar has a body that comprises a casing composed of the hollow box 1 and the surface panel 12, each of which is integrally formed by means of plastic injection molding, three-dimensional printing, or thermal fusion and allows for design freedom in the manufacturing side for variation and modification of the configuration thereof, including shapes and colors, thereby greatly expanding flexibility of the manufacturing side and eliminating various processes, including grinding and coloring, so as to make it not necessary for the manufacturing process to be changed or modified to suit complication of product configuration. For those concerned about the configuration or shape, the present invention provides an obvious advantage. In addition, the omission of the coloring process makes the manufacturing method of the present invention more environment-friendly. Next, a fibrous board 2 is positioned on an inner side of the surface panel 12. In the instant embodiment, a wooden board is provided as an example and the fibrous board 2 is subjected to machining or otherwise processing to form therein at least one receiving space 11, which allow pickups and/or a bridge of the electric guitar to be received in and retained on the fibrous board 2 to project outside the surface panel 12. A metal board 3 is then deposited at one side of the fibrous board 2 and in the instant embodiment, an aluminum board having a reduced weight is provided as an example. Through mounting sections 4 formed in the fibrous board 2 and the metal board 3 and in communication with each other, the fibrous board 2 and the metal board 3 are securely fixed to the surface panel 12. Under this condition, to maintain the electromagnetism based sounding characteristics of the electric guitar and to prevent feedback from inducing excessive noises, a stacked thickness of the two boards must be identical to a thickness of an interior space of the hollow box 1 in order to provide an effect resembling a piece of solid wood. Finally, strings are set, from the pickups, through openings 31 of the fibrous board 2 and openings 31 of the metal board, while accessory parts, such as a control switch, are set in receiving spaces 11 formed in the boards without the necessity of additional hole making. Then, the surface panel 12 and the hollow box 1 are combined together to complete the assembly of the present invention. In addition, the metal board 3 is provided with at least one notch 32, which helps make assembly easy and convenient and also reduces the total weight of the entire assembly.

The fibrous board 2 and the metal board 3 are arranged to stack on and overlap each other so that when a user plucks the strings, the strings vibrate and cut through magnetic induction lines of the pickups so as to induce electrical currents of various frequencies in conductor lines inside the guitar body. When such electrical currents pass through the fibrous board 2 and the metal board 3, due to inherent differences between the two boards in respect of hardness and density, the conduction speeds of the electrical currents are made different thereby providing an effect of tone holding. Further, the tone quality induced by the combination of metal and wood possesses a better effect than a conventional one that is induced simply by wood.

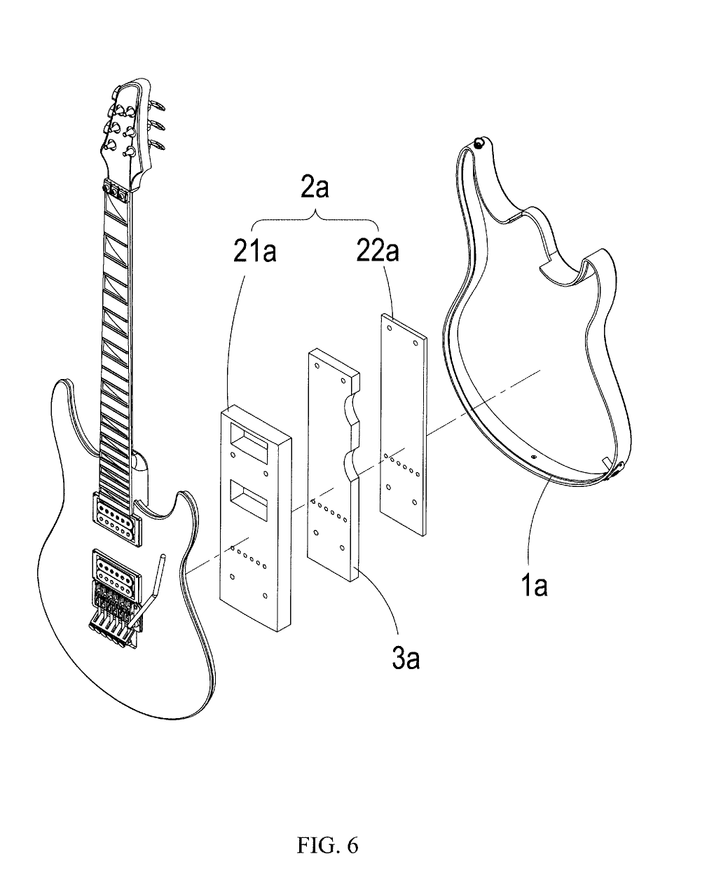

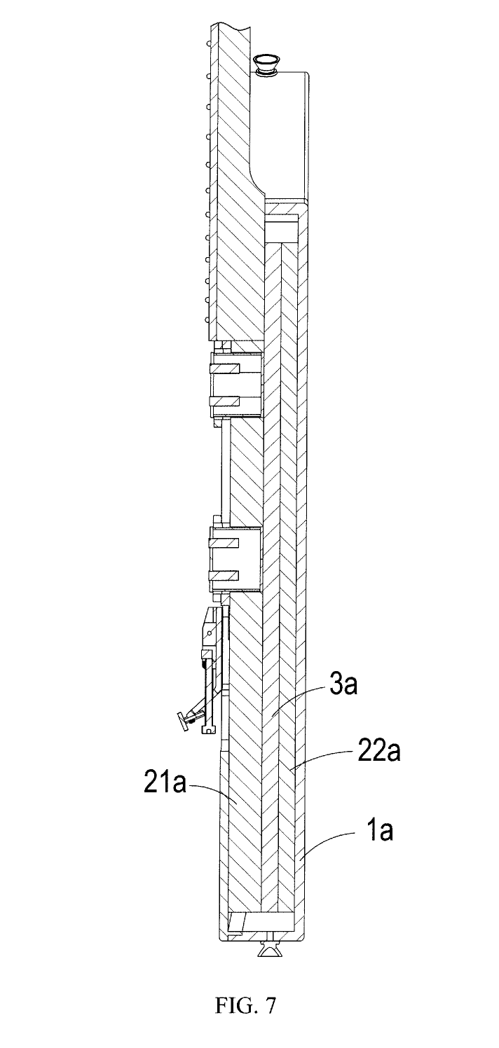

As shown in FIGS. 6 and 7, in another embodiment, the number of the fibrous board 2a used is changed to two, which are respectively referred to as a first fibrous board 21a and a second fibrous board 22a. Under this condition, the metal board 3a in interposed between the first fibrous board 21a and the second fibrous board 22a and the first fibrous board 21a is positioned against an inside surface of the hollow box 1a, while the second fibrous board 22a is positioned against an opposite inside surface of the hollow box 1a so that the three boards provide an arrangement that different materials are stacked in an alternating. As such, the size of the metal board 3a involved can be reduced in order to lower down the cost and reduce the total weight, and also provides additional variation to the tone quality.

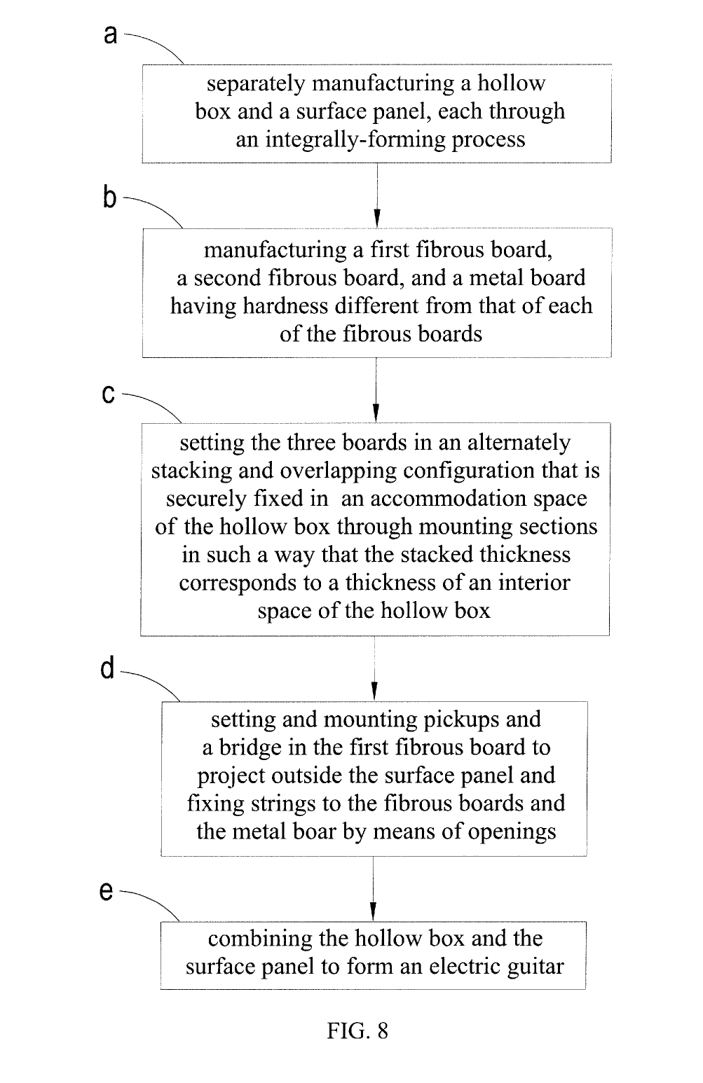

As shown in FIG. 8, to manufacture, a hollow box and a surface panel are separately manufactured, each through an integrally forming process, and separately, a first fibrous board, a second fibrous board, and a metal board having hardness different from that of each of the fibrous boards are manufactured. The three boards are then stacked and overlapping each other in such a way that different materials alternate each other. Then, the mounting sections are used to securely fixed in an accommodation space formed in the interior of the hollow box with the stacked thickness of the boards corresponding to a thickness of the interior space of the hollow box. Pickups and a bridge are then set into and retained on the first fibrous board to project outside the surface panel. Strings are put through the openings to be attached to the first and second fibrous boards and the metal board. Finally, the hollow box and the surface panel are combined together to form an electric guitar.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A manufacturing method of an electric guitar, comprising the following steps:
(a) making a hollow box through an integrally-forming process;
(b) making at least one fibrous board and at least one metal board having hardness different from that of the fibrous board;
(c) positioning and stacking the fibrous board and the metal board together in the hollow box in such a way that a stacked thickness corresponds to a thickness of an interior space of the hollow box; and
(d) mounting pickups and a bridge in the fibrous board to project outside the hollow box and fixing strings to the fibrous board and the metal board.

2. The manufacturing method of the electric guitar according to claim 1, wherein in step (a), the integrally-forming process of the hollow box comprises one of plastic injection molding, three-dimensional printing, and thermal fusion.

3. The manufacturing method of the electric guitar according to claim 1, wherein in step (c), the metal board is securely fixed to the fibrous board and the fibrous board is securely attached to an inside surface of a neck and the hollow box.

4. The manufacturing method of the electric guitar according to claim 1, wherein plural fibrous boards are included are respectively a first fibrous board and a second fibrous board, the metal board being sandwiched between the first fibrous board and the second fibrous board, the first fibrous board being positioned against an inside surface of the hollow box, the second fibrous board being positioned against another inside surface of the hollow box.

5. A structure of an electric guitar, comprising:
a hollow box;
at least one fibrous board, which is arranged in the hollow box; and
at least one metal board, which is arranged in the hollow box and is alternately stacked with the fibrous board, a thickness of the stack of the fibrous board and the metal board corresponding to a thickness of an interior space of the hollow box, the metal board having hardness greater than the fibrous board so as to produce an effect of tone holding and variation of tone quality.

6. The structure of the electric guitar according to claim 5, wherein the fibrous board comprises at least one receiving space formed therein for receiving and retaining a pickup or a bridge of the electric guitar.

7. The structure of the electric guitar according to claim 5, wherein the hollow box comprises a surface panel to which a neck of the electric guitar is mounted.

8. The structure of the electric guitar according to claim 5, wherein the metal board and the fibrous board each comprise a plurality of openings for receiving and mounting strings and at least one mounting section in communication with each other.

9. The structure of the electric guitar according to claim 5, wherein the metal board comprises at least one notch formed therein.

10. The structure of the electric guitar according to claim 5, wherein the fibrous board is a wooden board and the metal board is an aluminum board.
